(19) United States
(12) Patent Application Publication
(10) Pub. No.: US 2008/0305732 A1
(43) Pub. Date: Dec. 11, 2008

(54) Ventilation device for a motor vehicle as well as mold and method for producing the ventilation device

(75) Inventors: Thomas Dippel, Neuhemsbach (DE); Juergen Schenkenberger, Hochstellerhof (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Electronics & Components GmbH

(21) Appl. No.: 12/156,420

(22) Filed: May 30, 2008

(30) Foreign Application Priority Data
Jun. 6, 2007 (DE) 10 2007 026 385.8

(51) Int. Cl. B60H 1/34; B29B 11/06

(52) U.S. Cl. 454/155; 425/542

(57) ABSTRACT

A ventilation device (10) for a motor vehicle includes a housing (12) made of plastics and at least one ventilation flap (14) molded to the housing (12). The housing (12) has an opening (24) in the connecting region of each ventilation flap (14). A mold for producing the ventilation device (10) includes two cores (26, 28), which in an injection position define the contour of a ventilation flap (14) and in a demolding position provide for demolding the molded part formed in the mold. In the injection position, an opening (32) is formed between the two cores (26, 28) in the connecting region of the ventilation flap (14). In a method for producing the ventilation device (10) by means of the mold, the ventilation flap (14) is molded to the housing (12) through the opening (24) in the housing (12).

### TECHNICAL FIELD

This invention relates to a ventilation device for a motor vehicle. This invention furthermore relates to a mold for producing such ventilation device and a method for producing the ventilation device by means of the mold.

### BACKGROUND OF THE INVENTION

In a motor vehicle, a ventilation device serves to relieve an excess pressure in the interior of the vehicle, as it can occur when a door is slammed, a fan is running, an airbag deploys, etc. The ventilation device usually has a housing with an outer frame as well as longitudinal and transverse beams. One or more ventilation flaps are attached to the housing and in the closed position rest on the frame and/or on the longitudinal and transverse beams of the housing. The ventilation device is inserted into an opening of the vehicle body, the frame being provided with a circumferential seal.

Ventilation devices in which the ventilation flaps are mounted to the housing involve a high mounting effort. As regards the thickness of the ventilation flaps, it was found that thinner ventilation flaps cause less rattling noise. Eventually, the ventilation flaps should be rather flat, in order to ensure a sufficient tightness in the closed position.

A ventilation device comprising a housing made of plastics and at least one ventilation flap molded to the housing is known from European patent EP 0 912 357 B1. During production of the ventilation device, the ventilation flap is molded to the housing in the open position in an injection mold, starting from the free end of the ventilation flap.

Published German Patent Application DE 100 52 003 A1 discloses a ventilation device, in which the ventilation flap is molded, but not molded directly to the housing. Rather, a purely mechanical connection of the ventilation flap to the housing is desired, in that a sealing lip of the ventilation flap extends through a fixing slot in the longitudinal beam of the housing, the cross-section of the sealing lip being thickened on both sides of the slot.

It is an object of the invention, to provide for an efficient series production of a simply designed ventilation device, which can meet the usual requirements in terms of functionality.

### BRIEF SUMMARY OF THE INVENTION

According to the invention, a ventilation device for a motor vehicle comprises a housing made of plastics and at least one ventilation flap molded to the housing. The housing has an opening in the connecting region of each ventilation flap. This design allows to directly mold the ventilation flap to the frame or to a longitudinal beam in a simple manner from the back of the ventilation device.

The invention also provides a mold for producing a ventilation device in accordance with the invention. The mold has two cores, which in an injection position define the contour of a ventilation flap and in a demolding position provide for demolding the molded part formed in the mold. An opening is formed in the injection position between the two cores in the connecting region of the ventilation flap. After molding the housing, such mold can be used to introduce the plastic compound through the opening in the housing between the two cores to form the ventilation flap.

To provide for first molding the housing in the same mold, a sealing element is provided for optionally sealing the opening. This ensures that no plastic compound can enter between the cores while molding the housing.

What is particularly advantageous for an efficient series production of the ventilation device is a mold which includes a first part having a plurality of cavities and an opposite second part having nozzles for injecting various plastic compounds. The first part is transferable relative to the second part from a first injection position into a second injection position. Thus, various injection processes can be performed with the same mold for simultaneously producing a plurality of ventilation devices.

Preferably, the cavities are arranged such that in the second injection position first cavities take the same position as second cavities in the first injection position. This provides for a cyclic operation with successive injection processes without having to remove the intermediate products from the mold.

Finally, the invention also provides a method for producing a ventilation device according to the invention by means of a mold according to the invention. The method includes the step of molding the ventilation flap to the housing through the opening in the housing.

According to a particularly efficient embodiment the method includes the following steps:
molding housings in first cavities of the mold; and
molding ventilation flaps in second cavities of the mold;

the two steps being performed in parallel in the first injection position of the mold.

### BRIEF DESCRIPTION OF THE DRAWINGS

FIG. 1 shows a top view of a ventilation device in accordance with the invention;

FIG. 2 shows a bottom view of the ventilation device,

FIG. 3 shows cores of a mold of the invention with an additional sealing element;

FIG. 3a shows an enlarged view of the detail Z from FIG. 3 without sealing element;

FIG. 4 shows the cores of the mold with an injection nozzle for the housing;

FIG. 5 shows the cores of the mold with injection nozzles for the ventilation flaps and the seal;

FIG. 6 shows the cores of the mold in a first position;

FIG. 7 shows the cores of the mold in a second position;

FIG. 8 shows the ejection-side part of the mold; and

FIG. 9 shows the ejection-side and nozzle-side parts of the mold.

### DETAILED DESCRIPTION OF THE PREFERRED EMBODIMENTS

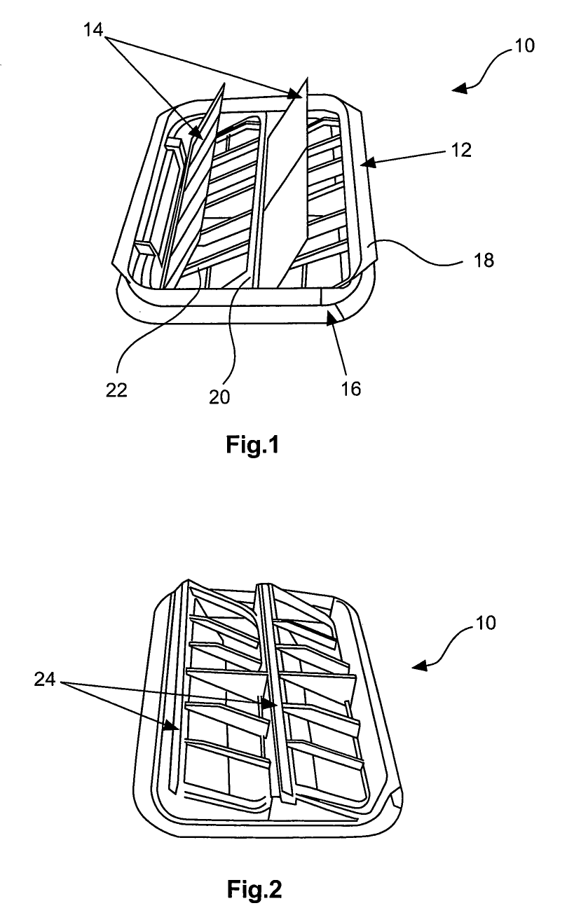

FIGS. 1 and 2 depict a ventilation device 10 produced by an injection molding method. The ventilation device 10 comprises a housing 12, ventilation flaps 14 and a seal 16 as basic components.

The elongated housing 12 is made of a rigid plastic material (a first injection molding component) and includes an outer frame 18, a longitudinal beam 20 and a plurality of transverse beams 22. Other embodiments with a different number of longitudinal or transverse beams are, however, also possible.

The very thin, flat and straight-edge ventilation flaps 14 are made of a softer plastic material (a second injection molding component) and are (injection)-molded to the frame 18 and/or to the longitudinal beam 20 such that they adhere to the same. To provide for molding the ventilation flaps 14 from the back of the housing 12, which will be explained in detail below, the frame 18 and the longitudinal beam each have a rear slot 24, as shown in FIG. 2. The slots 24 substantially extend along the entire length of the connecting region of the ventilation flaps 14. However, the housing is designed such that the slots 24 do not seriously impair the stability of the housing 12.

The seal 16 circumferentially molded to the frame 12 can be formed of the same material as the ventilation flaps 14 or of a third injection molding component.

In FIGS. 1 and 2, the ventilation device 10 is shown in the condition as it is removed from an injection mold. Upon removal from the mold, the ventilation flaps 14 molded in an opening position rest on the frame 18 and/or on the longitudinal beam 20 of the housing 12.

In the following, the process of manufacturing the ventilation device by a multi-component injection molding method will first be described with reference to a single ventilation device 10, and subsequently the cyclic series production of a plurality of ventilation devices 10 will be described.

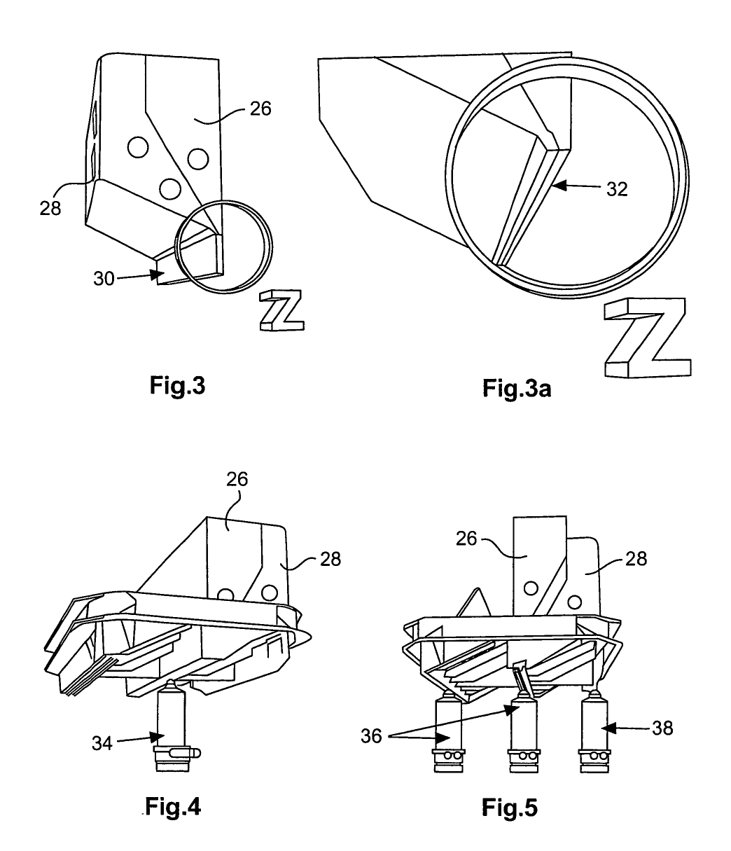

As shown in FIG. 3, the injection mold for producing a ventilation device 10 includes two cores 26, 28 which define the contour of a ventilation flap 14 and a sealing element 30 in represented by a spotting core. For the sake of simplicity, the components of the mold required for defining the contours of the housing 12 and of the seal 16 are not shown here. While the first contour-forming core 26 in the mold is stationary, the second contour-forming core 28 is movable in the mold. In the injection position of the contour-forming cores 26, 28 as shown in FIG. 3, the plastic compound for forming the ventilation flap 14 can be injected through an opening 32 formed between the two cores 26, 28 (FIG. 3a). Before this, during the injection of the plastic compound for forming the housing 12, the opening 32 is sealed by the sealing element 30.

In FIGS. 4 and 5 it is shown at which points the nozzles of the mold inject the injection molding components. As mentioned already, there is first injected the first injection molding component for forming the housing 12, for which purpose a first nozzle 34 is provided (FIG. 4). During this process, the sealing element 30 closes the opening 32 between the two contour-forming cores 26, 28, so that no material can enter between the cores 26, 28. Subsequently, the sealing element 30 is removed, and through the above-mentioned slots 24 in the frame 18 or in the longitudinal beam 20 the second injection molding component for forming the ventilation flap 14 is injected between the contour-forming cores 26, 28 via second nozzles 36. At the same time, the seal 16 is molded to the frame 18 via a third nozzle 38, wherein the plastic compound used for this purpose can be the same as the one used for the ventilation flap 14 or be a third injection molding component.

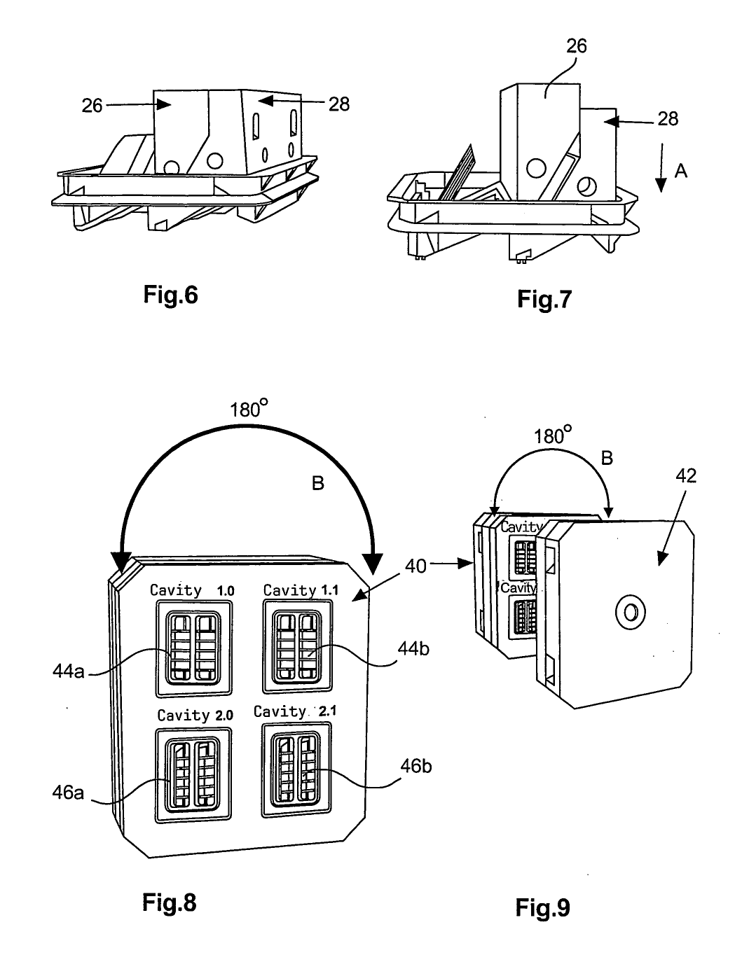

For demolding (removing from the mold) the finished ventilation device 10, the second contour-forming core 28 is advanced from the injection position as shown in FIG. 6 in the direction of arrow A into the demolding position as shown in FIG. 7. After releasing the ventilation flaps 14, the entire molded part is demolded by means of a non-illustrated ejector.

FIGS. 8 and 9 show an injection mold which provides for a cyclic series production of the ventilation device 10. The mold substantially comprises an ejection-side part 40 with a plurality of cavities and an opposed nozzle-side part 42 with the nozzles 34, 36, 38 for injecting the injection molding components. One of the two parts 40, 42 of the mold can be moved towards the other part up to a closed position of the mold and be moved away again (open position of the mold). The ejection-side part 40 is rotatable from a starting position through 180° about an axis of rotation, as indicated by arrow B. In the illustrated embodiment of the mold, the ejection-side part includes two first cavities 44a, 44b and two second cavities 46a, 46b, which are arranged symmetrically with respect to the axis of rotation, i.e. after a rotation through 180°, the first cavities 44a, 44b are located exactly at the same point as the second cavities 46a, 46b before, and vice versa.

At the beginning of the series production, the housings 12 are molded (first injection molding component) in the closed position of the mold with the nozzles 34 of the nozzle-side part 42 in the first two cavities 44a, 44b of the ejection-side part 40 by using the sealing elements 30. Then, the housings 12 are cooled. The mold is opened, the sealing elements 30 are removed from the first cavities 44a, 44b and the ejection-side part 40 is rotated through 180°. Upon closing the mold, the ventilation flaps 14 and the seals 16 now are molded (second and, possibly, third injection molding components) in the first cavities 44a, 44b. Parallel thereto, i.e. at the same time (in the same working step), the housings 12 are molded (first injection molding component) in the second cavities 46a, 46b by using the sealing elements 30.

After cooling the ventilation flaps 14 and the seals 16 in the first cavities 44a, 44b and the housings 12 in the second cavities 46a, 46b, the mold is opened. In the first cavities 44a, 44b, the second cores 28 are advanced into the demolding position, the ventilation flaps 14 are released and the molded parts are demolded by the ejectors. Thereafter, the ejectors and the second cores 28 are again returned into the injection position.

The ejection-side part 40 is rotated back into its starting position through 180°, so that again, as described above, housings 12 can be molded in the first cavities 44a, 44b and ventilation flaps 14 and seals 16 can be molded in the second cavities 46a, 46b. This cycle now can be repeated any number of times.

1. A ventilation device for a motor vehicle, the ventilation device comprising a housing made of plastics and at least one ventilation flap molded to the housing, the housing having an opening in the connecting region of each ventilation flap.

2. The ventilation device according to claim 1, wherein the opening is a slot which extends substantially along the length of the connecting region of the ventilation flap.

3. The ventilation device according to claim 1, further comprising a seal circumferentially molded to an outer frame of the housing.

4. The ventilation device according to claim 3, wherein the seal is formed of the same material as the ventilation flap.

5. The ventilation device according to claim 3, wherein the seal is formed of a different material than the ventilation flap.

6. A mold for producing a ventilation device according to claim 1, the mold comprising two cores, which in an injection position define the contour of a ventilation flap and in a demolding position provide for demolding the molded part formed in the mold, an opening being formed in the injection position between the two cores in the connecting region of the ventilation flap.

7. The mold according to claim 6, further comprising a sealing element for optionally sealing the opening.

8. The mold according to claim 6, wherein the first core is stationary and the second core is movable relative to the first core.

9. The mold according to claim 6, further comprising at least one nozzle for injecting a plastic material for forming the ventilation flap, wherein the nozzle can be placed such that the plastic material can be injected through the opening of the housing into the opening between the cores.

10. The mold according to claim 6, further comprising a first part having a plurality of cavities and an opposite second part having nozzles for injecting various plastic compounds, the first part being transferable relative to the second part from a first injection position into a second injection position.

11. The mold according to claim 10, wherein the cavities are arranged such that first cavities in the second injection position take the same position as second cavities in the first injection position.

12. The mold according to claim 11, wherein the first part is rotatable relative to the second part.

13. The mold according to claim 12, wherein the first part is movable between the first and second injection positions by a 180° rotation.

14. A method for producing a ventilation device according to claim 1 by a mold according to claim 6, the method including the step of molding the ventilation flap to the housing through the opening in the housing.

15. The method according to claim 14, further including the step of sealing the opening between the cores with the sealing element and the subsequent step of molding the housing.

16. The method according to claim 14, wherein together with the ventilation flap the seal is also molded to the outer frame of the housing.

17. The method according to claim 14, further including the following steps:
molding housings in first cavities of the mold; and
molding ventilation flaps in second cavities of the mold;
the two steps being performed in parallel in the first injection position of the mold.

18. The method according to claim 17, wherein after molding the ventilation flaps, the molded parts are removed from the mold and the mold is transferred into the second injection position.

19. The method according to claim 18, wherein the method steps are repeated cyclically.
